(19) United States
(12) Patent Application Publication
(10) Pub. No.: US 2008/0209683 A1
(43) Pub. Date: Sep. 4, 2008

(54) Sliding Hinge Device, Personal Portable Device Having The Sliding Hinge Device And Method Of Manufacturing The Sliding Hinge Device

(75) Inventor: Sang Ho Lee, Daegu (KR)

Correspondence Address: MILLER NASH LLP, 601 UNION STREET, SUITE4400, SEATTLE, WA, 98101-2352, US

(73) Assignee: SHELL-LINE CO., LTD., Gyeongsangbuk-do (KR)

(21) Appl. No.: 11/813,990

(22) PCT Filed: Oct. 24, 2005
(86) PCT No.: PCT/KR05/03531

§ 371 Date: Jul. 13, 2007

(30) Foreign Application Priority Data
Jan. 14, 2005 (KR) 10-2005-0003880
Feb. 16, 2005 (KR) 10-2005-0012850
Mar. 2, 2005 (KR) 10-2005-0017097

(51) Int. Cl. E05D 11/00

(52) U.S. Cl. 16/352

(57) ABSTRACT

A slide hinge device mounted between two terminal bodies opening and closing by a slide type. The slide hinge device includes a rail hinge unit and a slide hinge unit. The rail hinge unit includes a guide bar disposed parallel with a side of the rail plate, and the slide hinge unit includes a slide guide, in which a penetration hole corresponding to the guide bar is formed in the center thereof, for sliding along the guide bar and a guide frame bound with the slide guide as one body. Also, a lubricating bush is previously connected between the guide bar and a moving bush, and the rail hinge unit and the slide guide may be simultaneously molded by die casting or injection molding. The slide guide may be manufactured by using self-lubricating material. The hinge device using the guide bar may be molded via one molding process. Since, basically, the slide hinge device is formed by a single molding process, an error between components may be minimized.

### TECHNICAL FIELD

The present invention relates to a slide type personal portable device, and more particularly, to a slide type personal portable device, a slide hinge device mounted on the terminal, and a method of manufacturing the slide hinge device.

### BACKGROUND ART

Mobile phones may be generally divided into a flip type, a folder type, and a slide type, according to an external shape or operation method.

In a slide type phone, two sliding bodies are disposed while overlapped with each other and a display unit and key input unit are disposed in the same direction on the bodies, respectively. Generally, the slide type phone may exposure a display unit or key input unit on the rear by moving a front sliding body. For example, there is a slide type phone whose key input unit formed on a rear sliding body is exposed by pushing up a front sliding body. Also, there is a slide type phone whose display unit formed on a rear sliding body is exposed by moving downward a front sliding body on which a key input unit is formed.

A slide type mobile phone includes sliding bodies overlapped above and below. A slide hinge device connecting the both bodies is interposed between the sliding bodies to mutually connect the sliding bodies and enable the sliding bodies to slide. In association with a slide hinge device, hinge devices of various structures are disclosed. Among the disclosed hinge devices, there is a hinge device using a guide bar or shaft, whose bodies may precisely slide by using the guide bar.

FIG. 1 is a perspective view illustrating a conventional slide hinge device 100. Referring to FIG. 1, the conventional slide hinge device includes a guide rail element 110, a slide element 120 sliding on the guide rail element 110, and first and second torsion springs 130 and 140 promoting the sliding of the slide element 120.

The guide rail element 110 is formed of a rectangular board 112. First and second guide bars 150a and 150b are installed along both sides of the rectangular board 112 parallel to each other. The first and second guide bars 150a and 150b are separated from the both sides of the rectangular board 112 at a certain interval. Both ends of the first and second guide bars 150a and 150b are fastened to top and bottom supporters 114 and 116 of the rectangular board 112.

Also, top and bottom shock absorbing rubbers 152a to 152b′ are slipped on both top and bottom ends of the first and second guide bars 150a and 150b and both the top and bottom ends enter into the top and bottom supporters 114 and 116 and are fastened thereto. The top and bottom shock absorbing rubbers 152a to 152b′ are in the shape of a hat in order to cover the ends of the first and second guide bars 150a and 150b, prevent a direct collision between the guide rail element 110 and the slide element 120, and enable the first and second guide bars 150a and 150b installed along the guide rail element 110 in sliding of the slide element 120.

Two holes are formed adjacent to both outer edges of the rectangular board 112. An arm 132a of the first torsion spring 130 and an arm 142a of the second torsion spring 140 are inserted into the holes to rotate.

First and second guide sills 118a and 118b are formed on both sides of the rectangular board 112, opposite to the first and second guide bars 150a and 150b. In detail, the first guide sill 118a opposite to the first guide bar 150a and the second guide sill 118b opposite to the second guide bar 150b are formed as straight protrusions extended and protruded from the both sides of the rectangular board 112.

The slide element 120 may straightly slide on the guide rail element 110. For this, the slide element 120 includes first and second slide engagement portions 124a and 124b formed on both edges of a substrate 122. First and second guide holes 126a and 126b which the first and second guide bars 150a and 150b penetrate, respectively, are formed on the first and second slide engagement portions 124a and 124b. Two pairs of bearings are inserted into the first and second guide holes 126a and 126b to mitigate contact friction in sliding of the first and second guide bars 150a and 150b. The bearings 127a to 127b′ are generally formed of polyoxymethylene (POM). The guide rail elements 110 do not directly make contact with the slide elements 120, an impact may be relieved, and noise may be reduced by using the bearings 127a to 127b′ and the shock absorbing rubbers 152a to 152b′.

First and second rails 128a and 128b protruded toward each other are formed inside the first and second slide engagement portions 124a and 124b. The first and second rails 128a and 128b are engaged with the first and second guide sills 118a and 118b to slide, respectively. In this case, since there is a gap between the first and second rails 128a and 128b and the first and second guide sills 118a and 118b, the rails 128a an 128b do not directly make contact with the guide sills 118a and 118b in sliding. In sliding, the first and second guide bars 150a and 150b and the first and second guide holes 126a and 126b mainly lead the sliding movement of the sliding bodies, and the first and second guide sills 118a and 118b and the first and second rails 128a and 128b assist to suppress a deviation or diversion of the slide element 120 such that the slide element 120 stably slides on the guide rail element 110.

After assembling the slide hinge device 100, an upper body and lower body of a mobile phone are screwed to the guide rail element 110 and the slide element 120, respectively, thereby completing a slide type mobile phone (not shown). Since a slide type mobile phone is generally used by holding a lower body with a hand and pushing up an upper body corresponding to a cover, a guide rail element fastened to the upper body may move on a slide element fastened to the lower body.

Generally, the guide rail element 110 and the slide element 120 are formed of aluminum and manufactured by die casting. Generally, the first and second guide bars 150a and 150b are formed separately from the guide rail element 110. Accordingly, the lower supporter 116 has a structure separated from the rectangular board 112 and is engaged with the rectangular board 112 by inserting the first and second guide bars 150a and 150b. Since the first and second guide holes 126a and 126b for containing the first and second guide bars 150a and 150b can not be formed by die casting, the first and second guide holes 126a and 126b have to be formed by an additional process of making a hole after manufacturing the slide element 120. Next, the bearings 127a to 127b′ formed of POM are additionally inserted.

A slide hinge device using a guide bar or shaft may enable a slide body to stably slide. However, to manufacture the conventional slide hinge device, aluminum casting, hole-processing after aluminum extrusion molding, tap processing, T-cutting of a side, and coating by fluorine resin are required. Namely, by adding the guide bar structure, manufacturing the hinge device becomes complicated. By adding the hole-processing for the guide holes 126a and 126b, manufacturing cost or defect rate of a product may be increased. Also, due to the processes, manufacturing cost may be considerably increased.

### DISCLOSURE OF INVENTION

### Technical Goals

An aspect of the present invention provides a slide hinge device capable of being simply manufactured and a method of manufacturing the slide hinge device.

An aspect of the present invention provides a slide hinge device whose number of processes for manufacturing may be reduced and defect rate may be reduced and a method of manufacturing the slide hinge device.

### Technical Solutions

According to an aspect of the present invention, there is provided a slide hinge device including a rail hinge unit and a slide hinge unit. The rail hinge unit includes a rail plate and at least one guide bar disposed parallel with a side of the rail plate. The slide hinge unit includes a slide guide, in which a penetration hole corresponding to the at least one guide bar is formed in the center thereof, for sliding along the guide bar and a guide frame bound with the slide guide as one body. An elastic element interposed between the rail hinge unit and the slide hinge unit is further included. The elastic element may provide two directions of repulsion forces, which are opposite to each other and switched at a point on a movement path of the slide hinge unit. Accordingly, the slide hinge device moves along the slide guide on the guide bar, thereby providing excellent and smooth feel of sliding. In the slide hinge device, an upper or lower supporter is not required to be manufactured and an additional process for assembling the guide bar is not required because the rail hinge unit and the slide guide may be molded by insert injection molding or die casting at the same time after previously assembling the guide bar and a moving bush. Namely, since the rail hinge unit may be molded and fixed to the guide bar at the same time, an additional supporter is not required, and since the slide hinge unit is formed on the moving bush, an additional hole-processing is not required.

According to another aspect of the present invention, there is provided a slide hinge device including a rail hinge unit and a slide hinge unit. The rail hinge unit includes a rail plate and at least one guide bar disposed parallel with a side of the rail plate. The slide hinge unit includes a moving bush sliding along the guide bar, a slide guide formed as one body with the moving bush, and a guide frame bound with the slide guide as one body.

To manufacture the slide hinge device, the guide bar and the moving bush sliding along the guide bar are previously assembled and disposed in a mold, the rail hinge unit containing both ends of the guide bar and the slide guide containing the moving bush are sequentially molded by using the mold. The guide frame is installed onto the slide guide, thereby connecting the slide hinge unit as one body. Also, a lubricating bush is previously connected between the guide bar and the moving bush, and the rail hinge unit and the slide guide are simultaneously molded by die casting or injection molding.

In a conventional slide hinge device having a guide bar, the guide bar has to be additionally assembled and, for this, an upper supporter or lower supporter is separately manufactured from a rail plate and the upper supporter or lower supporter has to be assembled by using a screw or other fastener after assembling the guide bar.

Also, since a slide hinge unit is manufactured by die casting or injection molding, a hole vertically penetrating the slide hinge unit is difficult to be formed and a guide hole is formed via additional hole-processing. Though using extrusion molding, barrel polishing is required. Also, after forming the guide hole, a bearing formed of resin such as polyoxymethylene (POM) has to be inserted, but it is very ineffective because dimensions of the guide hole and the bearing are small and, currently, the insertion is manually performed.

However, in the slide hinge device according to the present invention, an upper or lower supporter is not additionally manufactured and an additional process of assembling a guide bar is not required. Also, an additional process for forming a hole or inserting a bearing is not required, because the guide bar and a moving bush are previously assembled and a rail hinge unit and a slide guide may be molded by insert injection molding or die casting by a single molding process. Namely, since the rail hinge unit may be molded and may fix the guide bar at the same time, an additional supporter is not required, and since the slide hinge is formed on the moving bush, an additional hole-processing is not required.

According to still another aspect of the present invention, there is provide a slide hinge device including a rail hinge unit and a slide hinge unit.

The rail hinge unit includes a rail plate and at least one guide bar disposed parallel with a side of the rail plate. The slide hinge unit includes a slide guide, in which a penetration hole corresponding to the guide bar is formed in the center thereof, formed of self-lubricating material and a guide frame bound with the slide guide as one body. Accordingly, the guide bar is inserted into the penetration hole of the slide guide, and the slide guide formed of self-lubricating material slides along the guide bar. In this case, since the slide guide may be manufactured via injection molding, the process of manufacturing becomes simplified.

Structural merits and economic advantages of the slide hinge device may be applied to a personal portable device. The personal portable device may include a first terminal body and a second terminal body in addition to the slide hinge device. The rail plate of the slide hinge device may be installed onto the first terminal body, and the guide frame may be installed onto the second terminal body.

In the present specification, a personal portable device indicates a portable electric/electronic device such as a Personal Digital Assistant (PDA), a smart phone, a handheld PC, a mobile phone, and an MP3 player, which may include a predetermined communication module such as a Code Division Multiple Access (CDMA) module, a Bluetooth module, an Infrared Data Association (IrDA) module, and a wired/wireless LAN card and may be used as a concept designating a terminal having a predetermined operation ability by including a predetermined microprocessor executing a function of replaying multimedia.

### BRIEF DESCRIPTION OF DRAWINGS

FIG. 1 is a perspective view illustrating a conventional slide hinge device;

FIG. 2 is a top view illustrating a slide hinge device according to a first embodiment of the present invention;

FIG. 3 is a perspective view illustrating the slide hinge device of FIG. 2;

FIGS. 4 through 10 are perspective views or cross-sectional views illustrating a method of manufacturing the slide hinge device of FIG. 2;

FIG. 11 is a perspective view illustrating a slide hinge device according to a second embodiment of the present invention;

FIG. 12 is an exploded perspective view illustrating the slide hinge device of FIG. 11;

FIG. 13 is a perspective view illustrating a slide hinge device according to a third embodiment of the present invention;

FIG. 14 is an exploded perspective view illustrating the slide hinge device of FIG. 13;

FIG. 15 is a cross-sectional view illustrating a mold for manufacturing the slide hinge device of FIG. 13;

FIG. 16 is a top view illustrating a slide hinge device according to a fourth embodiment of the present invention;

FIG. 17 is a perspective view illustrating the slide hinge device of FIG. 16;

FIG. 18 is a cross-sectional view illustrating a first mold for describing a method of manufacturing the slide hinge device of FIG. 16;

FIG. 19 is a cross-sectional view illustrating a second mold for describing a method of manufacturing the slide hinge device of FIG. 16;

FIG. 20 is a partial cross-sectional view illustrating a screw hole of a slide guide according to an embodiment of the present invention; and

FIG. 21 is an exploded perspective view illustrating a slide hinge device according to a fifth embodiment of the present invention.

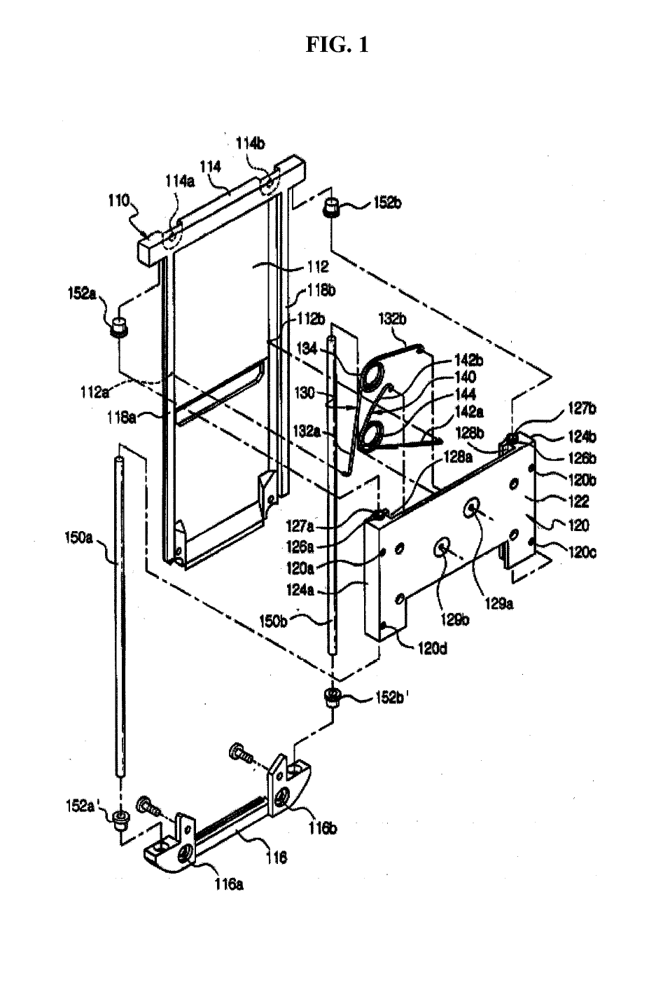

### BEST MODE FOR CARRYING OUT THE INVENTION

Hereinafter, embodiments of the present invention will be described in detail with reference to the attached drawings. However, the present invention is not limited or defined by the embodiments.

### Embodiment 1

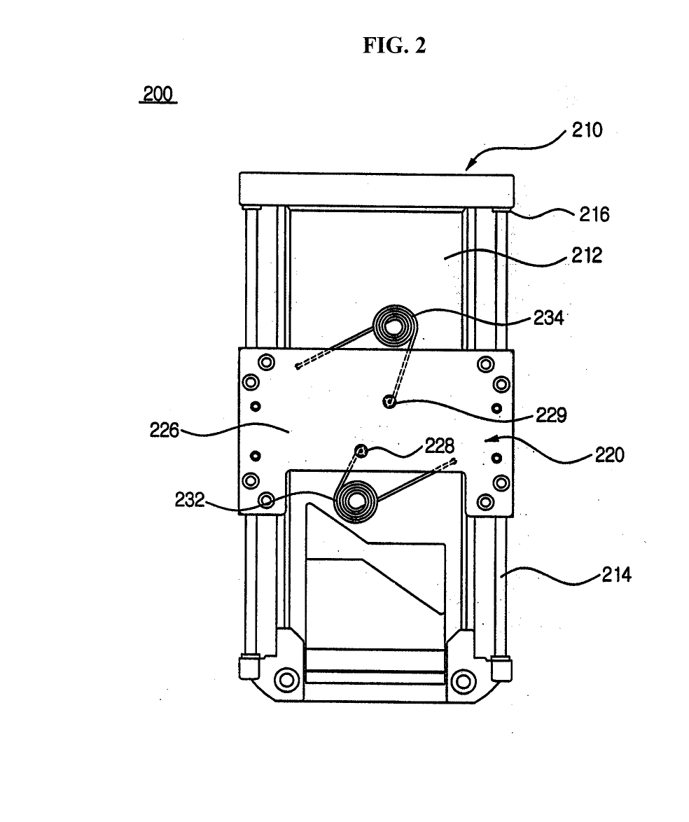

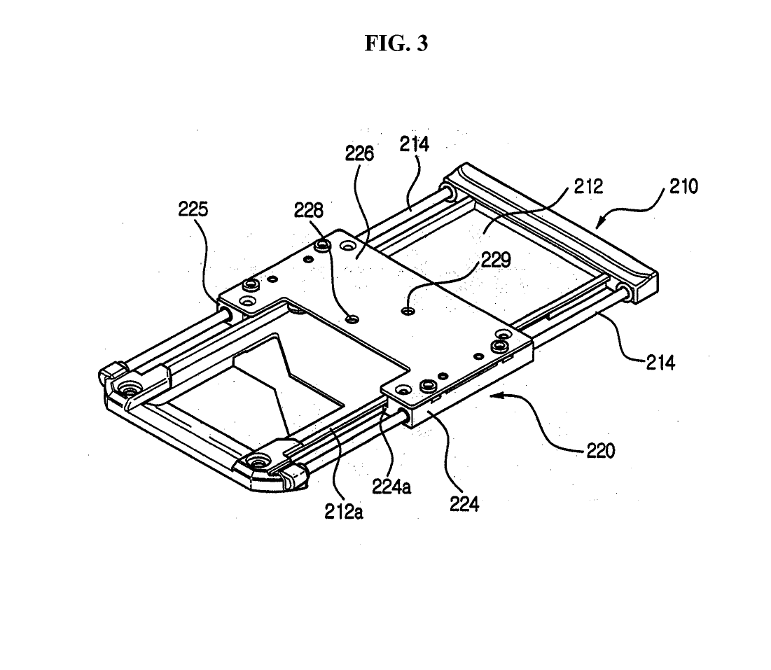

FIG. 2 is a top view illustrating a slide hinge device 200 according to a first embodiment of the present invention, and FIG. 3 is a perspective view illustrating the slide hinge device 200 of FIG. 2.

Referring to FIGS. 2 and 3, the slide hinge device 200 includes a rail hinge unit 210, a slide hinge unit 220, a first torsion spring 232, and a second torsion spring 234. In a slide type personal portable device (not shown), the rail hinge unit 210 and slide hinge unit 220 are fixed to terminal bodies, respectively, and the terminal bodies may be open and closed in the slide type by moving between the rail hinge unit 210 and slide hinge unit 220 interposed between the terminal bodies. Generally, the rail hinge unit 210 is installed onto a front terminal body equipped with a display unit, and the slide hinge unit 220 is installed onto a rear terminal body equipped with a keypad and battery.

The terminal bodies may include internal and external parts and circuit configuration including general terminal functions. The terminal bodies may include a terminal case, a keypad, a display module, a wireless communication module, a battery, a microphone, and a receiver. Depending upon manufacturers, the internal configuration may be different.

The rail hinge unit 210 includes a rail plate 212 and two guide bars 214 disposed at both sides of the rail plate 212 parallel to each other. Upper and lower ends of the rail plate 212 are horizontally extended, and an end of the guide bar 214 is contained and fixed to the extended portion of the rail plate 212. The rail plate 212 may be formed as one body formed of the same material and may not include a structure capable of being separated. Also, a guide sill 212a is formed in a longitudinal direction, on a side of the rail plate 212 adjacent the guide bar 214. The guide sill 212a prevents the slide hinge unit 220 becoming separated from the rail hinge unit 210. When the slide hinge unit 220 normally moves, the guide sill 212a is separated from the slide hinge unit 220 at a predetermined interval.

Also, dampers 216 formed in the shape of a ring are provided adjacent to connection portions of the guide bar 214 and the rail plate 212. The dampers 216 reduce an impact and noise caused by a bump of the slide hinge unit 220 and the rail hinge unit 210. The dampers may have various cross-sections such as a circle or square. The dampers 216 may be formed of crude rubber or other resins, such as conventional shock-absorbing rubber, having shock absorbing ability. Though the conventional shock-absorbing rubber is formed in the shape of a hat and covers the end of the guide bar 214, the dampers 216 of FIGS. 2 and 3 are formed in the shape of a ring and their positions may be controlled on the guide bar 214.

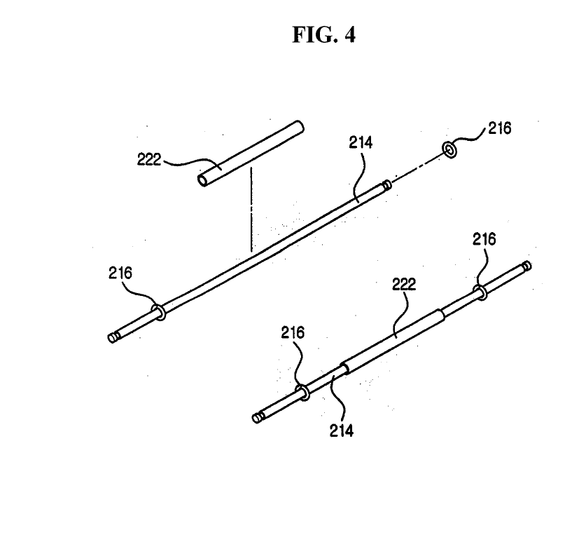

The slide hinge unit 220 includes a moving bush 222 (shown in FIG. 4), slide guides 224 and 225, and a guide frame 226. The moving bush 222 may be formed in the shape of a tube for containing the guide bar 214 and may be formed of self-lubricant material such as brass. Since the slide guides 224 and 225 may be manufactured by casting or injection molding, the moving bush 222 disposed in a mold may be also generally formed of material having thermal resistance.

The slide guides 224 and 225 are formed as one body around the moving bush 222. According to a manufacturing method of the present invention, since the slide guides 224 and 225 are shaped on the moving bush 222, the slide guides 224 and 225 are formed as one body with the moving bush 222. However, the slide guides 224 and 225 may be formed in one body with the moving bush 222 by other methods in addition to the methods of casting and injection molding.

In response to forming the guide sill 212a on the side of the rail plate 212, a guide protrusion 224a is formed on the side of the slide guides 224 and 225, opposite to the guide sill 212a. The guide protrusion 224a may be also formed continuously in a longitudinal direction of the slide guide 224 and 225. However, though discontinuously formed, the guide protrusion may prevent the slide hinge unit and the rail hinge unit 210 from mutual separation.

The slide guides 224 and 225 and the moving bush 222 may rotate around the guide bar 214, respectively. Only, since the slide guides 224 and 225 are connected to each other by the guide frame 226, the slide guides may only perform a linearly reciprocating motion along the guide bar 214. A locking hole for a screw or other locking elements is formed on the slide guides 224 and 225 and the guide frame 226. Accordingly, after molding the rail hinge unit 210 and the slide guides 224 and 225, the slide guides 224 and 225 are connected to each other by the guide frame 226, thereby providing the slide hinge unit 220.

As shown in FIG. 2, an elastic element interposed between the rail hinge unit 210 and the slide hinge unit 220 may be further included. The elastic element may provide two directions of repulsion forces, which are opposite to each other and switched at a point on a movement path of the slide hinge unit 220. Accordingly, when a user transfers a first terminal body by a certain distance from an initial position, a direction of force is switched between the hinge unit 210 and the slide hinge unit 220, thereby automatically moving on other paths.

For this, the first torsion spring 232 is connected to a first spring bush 218 of the rail hinge unit 210 and a first spring rivet 228 of the slide hinge unit 220 to rotate, and the second torsion spring 234 is connected to a second spring bush 219 of the rail hinge unit 210 and a second spring rivet 229 of the slide hinge unit 220 to rotate.

Hereinafter, a method of manufacturing the slide hinge unit of FIG. 2 will be described.

FIGS. 4 through 10 are perspective views or cross-sectional views illustrating a method of manufacturing the slide hinge device of FIG. 2.

Referring to FIG. 4, the guide bar 214 and the moving bush 222 are provided. Since ends of the guide bar 214 are contained by the rail plate 212 via casting or injection molding, an inner projection is formed on the end of the guide bar 214, thereby securely fixing the end of the guide bar 214 to the rail plate 212.

The moving bush is formed of brass and provided as being slipped on the guide bar 214. Also, after slipping the moving bush 222 on the guide bar 214, the damper 216 formed in the shape of a ring is slipped on the guide bar, on each side of the moving bush 222. The damper reduces an impact and noise and may be slipped on the guide bar 214 before the both ends of the guide bar 214 are contained by the rail plate 212. If the damper 216 is formed in the shape of a letter C, after molding the rail plate 212, the damper 216 may be slipped on the guide bar 214.

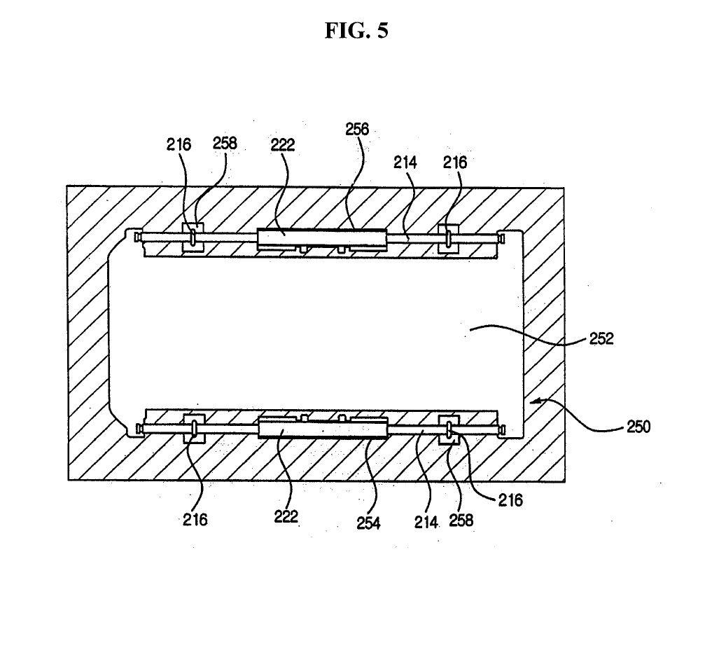

Referring to FIG. 5, the assembled guide bar 214 and moving bush 222 are disposed in a mold 250. The mold 250 may simultaneously mold the rail plate 212 and the slide guides 224 and 225, and include a first mold cavity 252 for molding the rail plate 212 and second mold spaces 254 and 256 for molding the slide guides 224 and 225. The first and second mold spaces 252, 254, and 256 are separated from each other and may separately mold the rail plate 212 and the slide guides 224 and 225.

Also, the mold 250 further includes a marginal space 258 located on the guide bar 214, adjacent to the second mold spaces 254 and 256. The marginal space 258 is a space for not molding but temporarily protecting the damper 216. At the beginning of a process of slipping the damper 216 on the guide bar 214, a position of insertion may be controlled in order to dispose the damper 216 in the marginal space 258.

To mold the rail plate 212 and the slide guides 224 and 225, the methods of die casting or insert injection molding may be used. Accordingly, metal such as aluminum may be used in addition to resins such as engineering plastic (EP).

In the mold 250, the first mold space 252 includes a guide sill molding part for molding the guide sill 212a formed in a longitudinal direction on a side of the rail hinge unit 210, and an end of the guide sill molding part is horizontally formed. However, though the second mold spaces 254 and 256 include a guide protrusion molding part for molding the guide protrusion 224a engaged with the guide sill 212a, the guide protrusion molding part is formed downward instead of in a horizontal direction. Namely, the guide protrusion molding part faces a vertical direction or other directions and cross each other.

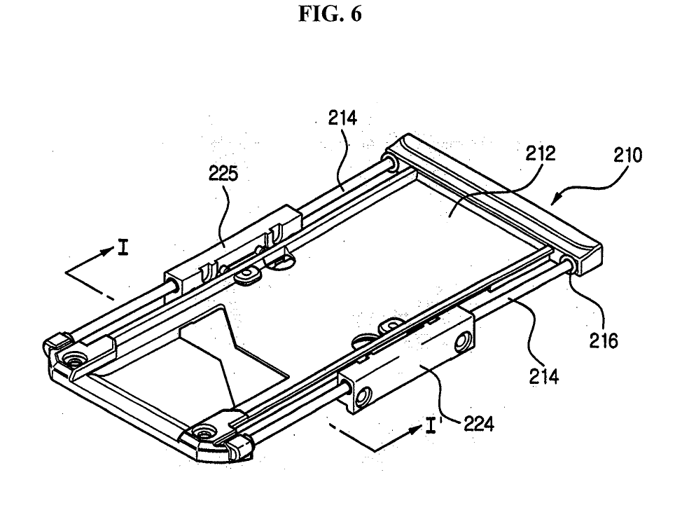

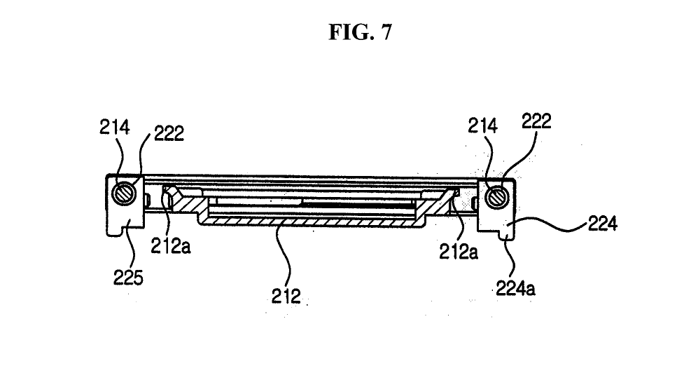

Consequently, as shown in FIGS. 6 and 7, the molded rail plate 212 and the slide guides 224 and 225 are formed as one body with the guide bar 214. The guide protrusion 224a of the slide guides 224 and 225 is turned downward. It is difficult to maintain a structure engaged with each other as it is and simultaneously mold the guide sill 212a and the guide protrusion 224a. Accordingly, in the process of molding, the guide protrusion 224a is turned upward or downward, thereby there is no vertically overlapped part in the slide guides 224 and 225 and the rail plate 212 and molding the slide guides 224 and 225 simultaneously with maintaining a state of being engaged with the rail hinge unit 210.

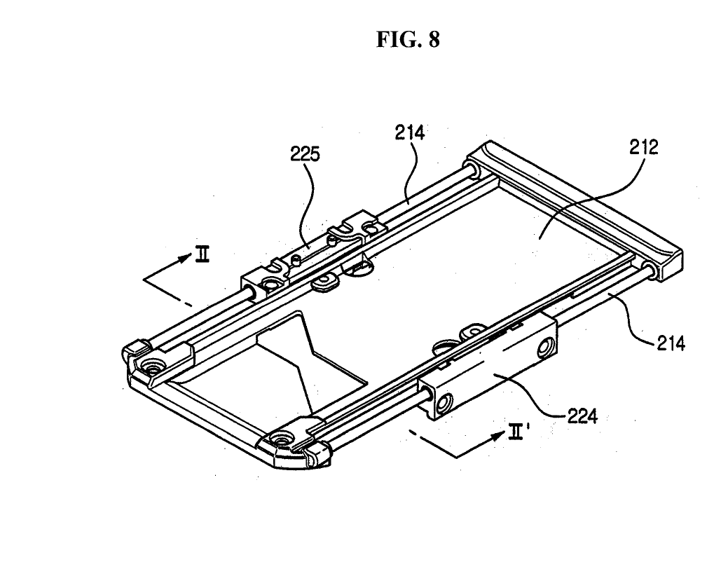

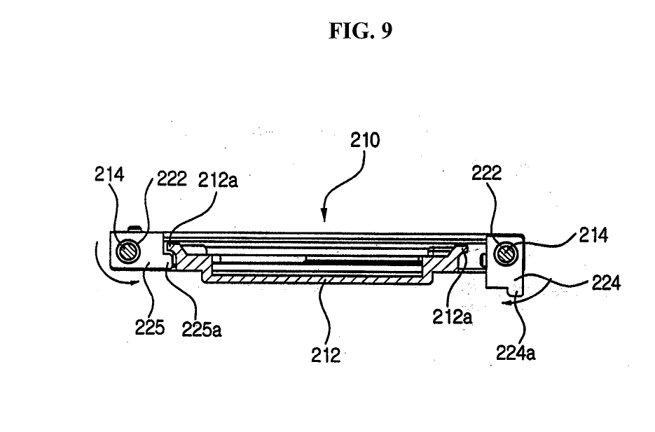

Referring to FIGS. 8 and 9, the guide protrusion 224a may be engaged with the guide sill 212a by rotating the molded slide guides 224 and 225. As shown in FIGS. 6 and 7, even if the vertically overlapped portions may exist, they may be molded by a single molding process by molding the slide guides 224 and 225 with rotating them by approximately 90 degrees, and the guide protrusion 224a faces the guide sill 212a by rotating the slide guides 224 and 225 to their original positions.

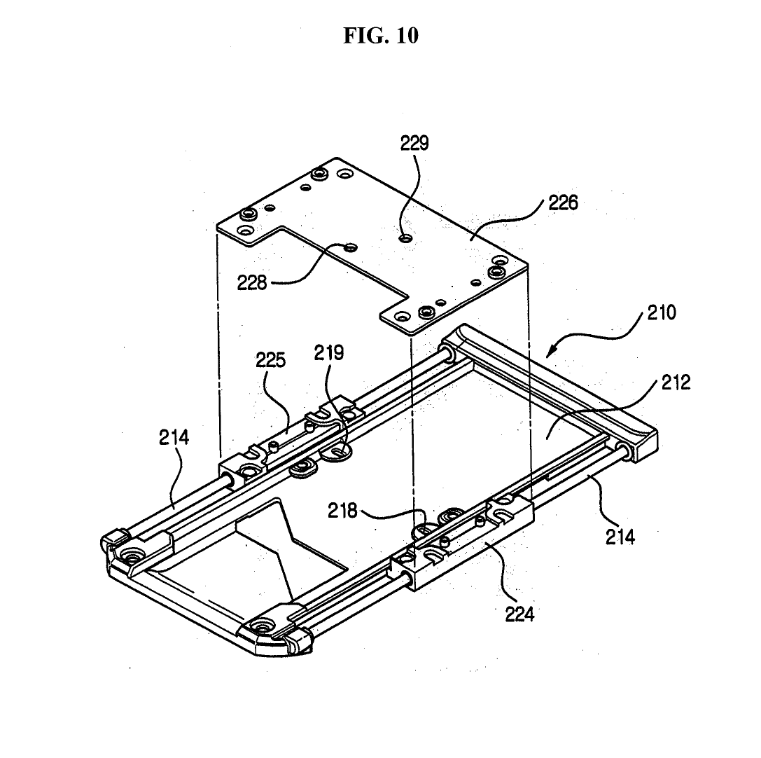

Referring to FIG. 10, the locking hole is turned upward by rotating the slide guides 224 and 225, and the slide guides 224 and 225 may be coupled together by the guide frame 226. The slide guides 224 and 225 is bound with the guide frame 226 and move along the guide bar 214 together with the guide frame 226.

In this case, before or after assembling the guide frame 226, the first and second torsion springs 232 and 234 may be interposed between the rail hinge unit 210 and the slide hinge unit 220. The first torsion spring 232 is connected to the first spring bush 218 of the rail hinge unit 210 and the first spring rivet 228 of the slide hinge unit 220 to rotate, and the second torsion spring 234 is connected to the second spring bush 219 of the rail hinge unit 210 and the second spring rivet 229 of the slide hinge unit 220.

As described above, after manufacturing the slide hinge device 200, the rail hinge unit 210 and the slide hinge unit 220 may be installed onto the first terminal body and the second terminal body of the personal portable device, respectively. The first and second terminal bodies may reciprocate by the slide hinge device 200, and the rail hinge unit 210 and the slide hinge unit 220 may relatively move by using the guide bar 214, thereby stably moving.

### Embodiment 2

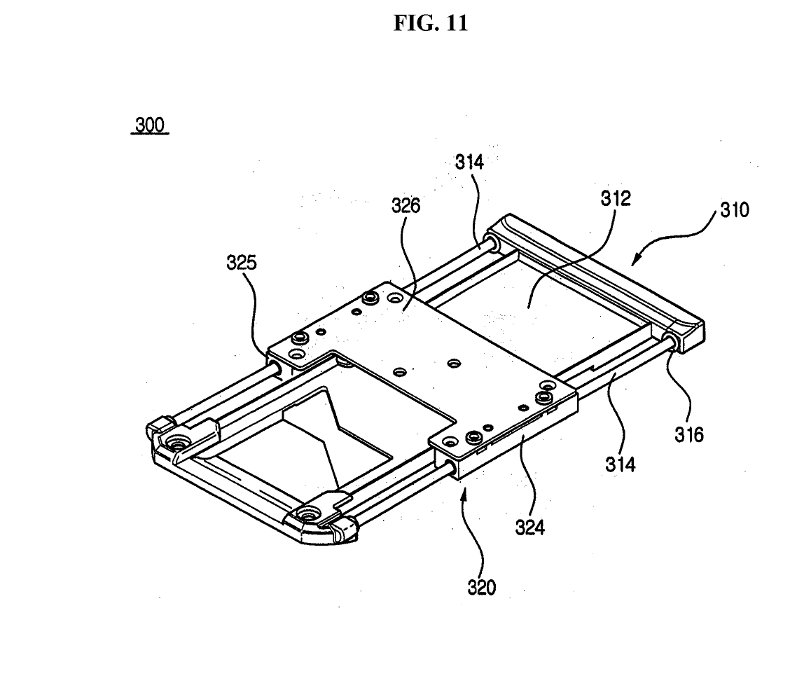

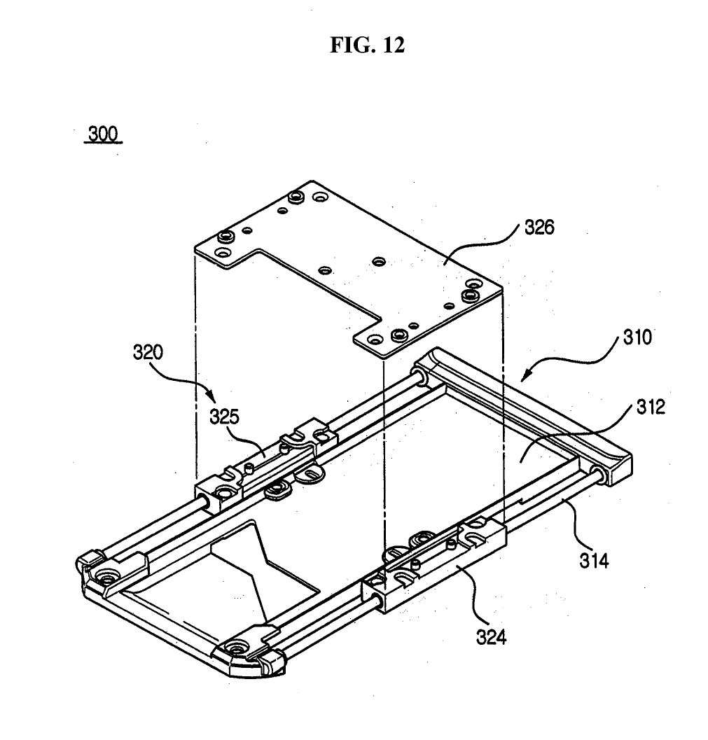

FIG. 11 is a perspective view illustrating a slide hinge device 300 according to a second embodiment of the present invention, and FIG. 12 is an exploded perspective view illustrating the slide hinge device 300 of FIG. 11.

Referring to FIGS. 11 and 12, the slide hinge device 300 includes a rail hinge unit 310, a slide hinge unit 320, a first torsion spring, and a second torsion spring. In a slide type personal portable device (not shown), the rail hinge unit 310 and slide hinge unit 320 are fixed to terminal bodies, respectively, and the terminal bodies may be open and closed in the slide type by movement between the rail hinge unit 310 and slide hinge unit 220 interposed between the terminal bodies.

The rail hinge unit 310 includes a rail plate 312 and two guide bars 314 disposed at both sides of the rail plate 312 parallel to each other. Upper and lower ends of the rail plate 312 are horizontally extended, and an end of the guide bar 314 is contained and fixed to the extended portion of the rail plate 312.

The slide hinge unit 320 includes a moving bush, slide guides 324 and 325, and a guide frame 326. The moving bush may be formed in the shape of a tube for containing the guide bar 314, and the slide guides 324 and 325 are manufactured to form one body with the moving bush by casting or injection molding. The slide guides 324 and 325 are connected to each other by the guide frame 326, and the guide frame 326 connects the slide guides 324 and 325 to each other, thereby providing the slide hinge unit 320.

Different to the slide hinge device 300 as shown in FIG. 11, the rail plate 312 of the present embodiment does not include a guide sill vertically formed on the side. Also, in association with this, the slide guides 324 and 325 do not include a guide protrusion corresponding to the guide sill. Without the guide sill and the guide protrusion, the terminal bodies of the personal portable device may slide with ease.

An elastic element interposed between the rail hinge unit 310 and the slide hinge unit 320 may be further included. The elastic element may provide two directions of repulsion forces, which are opposite to each other and switched at a point on a movement path of the slide hinge unit 220. For example, two torsion springs may be used as the elastic element. The two torsion springs may be interposed between the rail hinge unit 310 and the slide hinge unit 320 and may generate a force to open and close the slide hinge device.

When the assembled guide bar 314 and the moving bush are disposed in a mold 350, a first mold space 352 may not be adjusted to cross with second mold spaces 354 and 356 and may be formed to be engaged with the second mold spaces 254 and 356.

To mold the rail plate 312 and the slide guide 324 and 325, die casting or insert injection molding may be used. Accordingly, metal such as aluminum may be used as material in addition to resin such as EP.

Referring to FIG. 12, though the slide guides 324 and 325 are not rotated, a locking hole may face upward. The slide guides 324 and 325 may be connected to each other by using the guide frame 326.

As described above, after manufacturing the slide hinge device 300, the rail hinge unit 310 and the slide hinge unit 320 may be installed onto a first terminal body and a second terminal body of a personal portable device, respectively. The first and second terminal bodies may reciprocate by the slide hinge device 300. The rail hinge unit 310 and the slide hinge unit 320 move relative to each other by using the guide bar 314, thereby providing stable movement.

### Embodiment 3

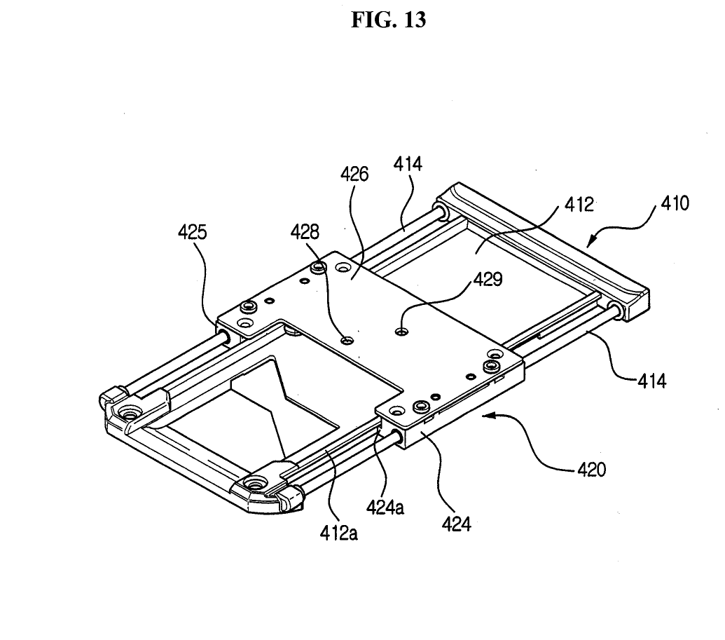

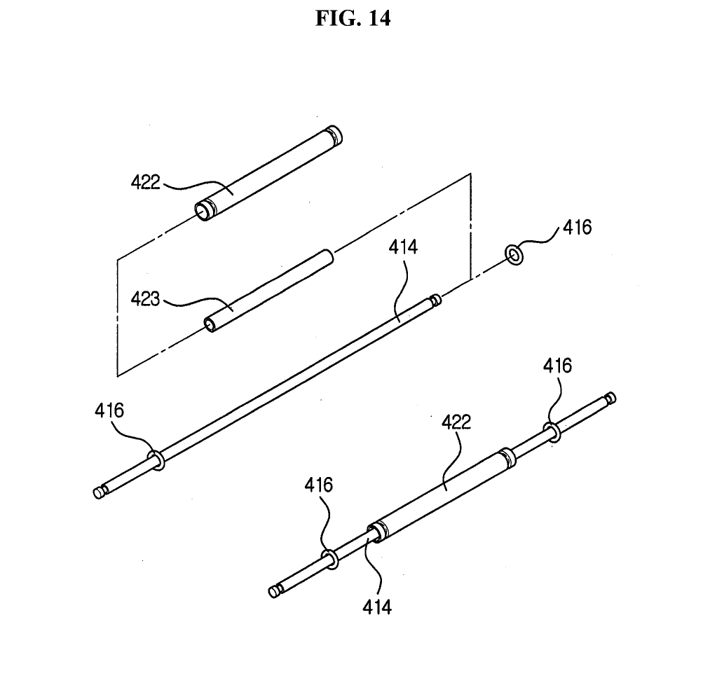

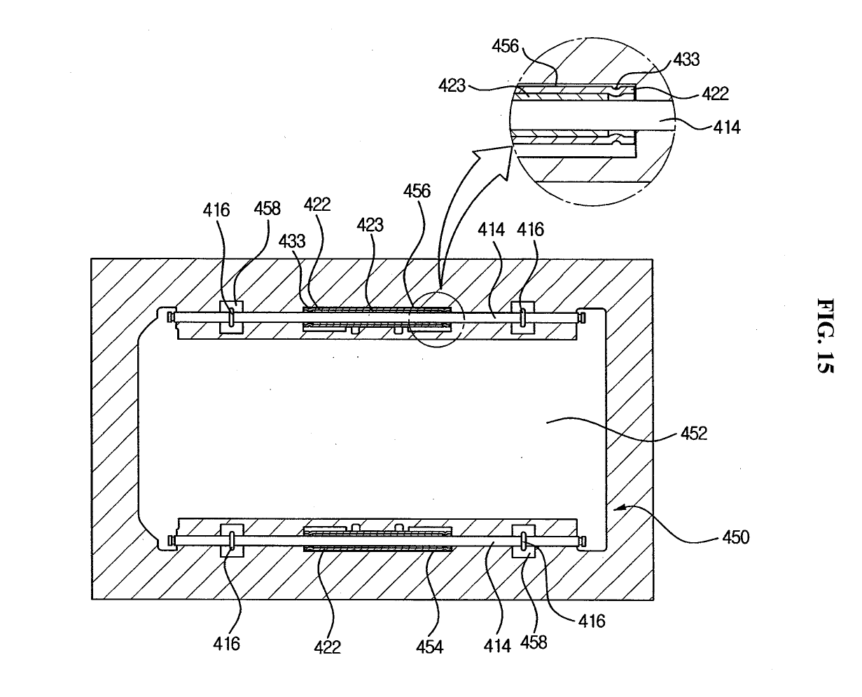

FIG. 13 is a perspective view illustrating a slide hinge device according to a third embodiment of the present invention, FIG. 14 is an exploded perspective view illustrating the slide hinge device of FIG. 13, and FIG. 15 is a cross-sectional view illustrating a mold for manufacturing the slide hinge device of FIG. 13.

Referring to FIGS. 13 through 15, a guide bar 414, a lubricating bush 423, and a moving bush 422 are provided. Since a part of an end of the guide bar 414 is contained in a rail plate 412 by casting or injection molding, an inner projection is formed on the end of the guide bar 414, thereby securely fixing the end of the guide bar 414 to the rail plate 412.

The lubricating bush 423 is formed in the shape of a tube capable of containing the guide bar 414. Since the lubricating bush 423 makes contact with the guide bar 414, abrasions, dust, and noise caused by friction may easily occur. Accordingly, material having excellent mechanical, thermal, and chemical properties while in extended use over a wide temperature range and having dimensional stability while preserving precise dimensions is required. Therefore, the lubricating bush 423 is formed of polymer material having excellent self-lubricating, fatigue resistant, antifriction, and wear-proof properties, such as POM. An alloy having excellent corrosion resistance, solidity, and antifriction, such as phosphor bronze widely used as material of springs or mechanical components may be used as the lubricating bush 423.

Also, the lubricating bush 423 is interposed between the guide bar 414 and the moving bush 422 having thermal resistance. The moving bush 422 is formed of brass, stainless steel, or other metals having thermal resistance. The lubricating bush 423 may be interposed between the guide bar 414 and the moving bush 422 to restrict direct friction between the guide bar 414 and the moving bush 422.

The moving bush 422 is formed in the shape of a tube capable of containing the lubricating bush 423. An outer radius of the lubricating bush 423 is determined to keep contact of an inner surface of the moving bush 422 and an inner radius of it is determined to contain the guide bar 414. Also, since the moving bush 422 has to move with the lubricating bush 423 on the guide bar 414, an inner projection protruded inward is provided on both ends of the moving bush 422, thereby preventing the lubricating bush 423 from moving relatively to the moving bush 422. Since the inner projection 433 is provided to fix the lubricating bush 433 to the moving bush 422, there is no range restriction on a shape, number, and position in which the object can be achieved. Accordingly, the inner projection 433 may be provided with no restriction in number, from the outside to the inside. Without providing the inner projection, the moving bush 422 may be fixed to the lubricating bush 433 by bending and enclosing the both ends of the moving bush 433.

The lubricating bush 423 and the moving bush 422 are provided being slipped on the guide bar 414. After slipping the lubricating bush 423 and the moving bush 422 on the guide bar 414 one after the other, a damper 416 formed in the shape of a ring is slipped on the guide bar 414, adjacent to the both ends of the moving bush 422. The damper 416 is for reducing an impact and noise and may be slipped on the guide bar 414 before both ends of the guide bar 414 are contained by the rail plate 412. When the damper 416 is formed in the shape of a letter C, the damper 416 may be slipped on the guide bar 414 after molding the rail plate 412.

Referring to FIG. 15, the assembled guide bar 414, lubricating bush 423, and moving bush 422 are disposed in a mold 450. The mold 450 may mold the rail plate 412 and the slide guides 424 and 425 at the same time and includes a first mold space 452 for molding the rail plate 412 and second mold spaces 454 and 456 for molding the slide guides 424 and 425. The first and second mold spaces 452, 454, and 456 are separated from each other and may mold the rail plate 412 and the slide guides 424 and 425 separated from each other.

Also, the mold space 450 includes a marginal space 458 located on the guide bar 414, adjacent to the second mold spaces 454 and 456. The marginal space is a space for temporarily protecting the damper 416 rather than a space for molding. At the beginning of a process of slipping the damper 416 on the guide bar 414, a position of insertion may be controlled in order to dispose the damper 416 in the marginal space 458.

To mold the rail plate 412 and the slide guides 424 and 425, the methods of die casting or insert injection molding may be used. Accordingly, metal such as aluminum may be used in addition to resins such as engineering plastic (EP).

In the mold 450, the first mold space 452 includes a guide sill molding part for molding the guide sill 412a formed in a longitudinal direction on the side of the rail hinge unit 410, and an end of the guide sill molding part is horizontally formed. However, though the second mold spaces 454 and 456 include a guide protrusion molding part for molding the guide protrusion 424a engaged with the guide sill 412a, the guide protrusion molding part is formed downward instead of in a horizontal direction. Namely, the guide protrusion molding part faces vertical direction or other directions and cross each other.

### Embodiment 4

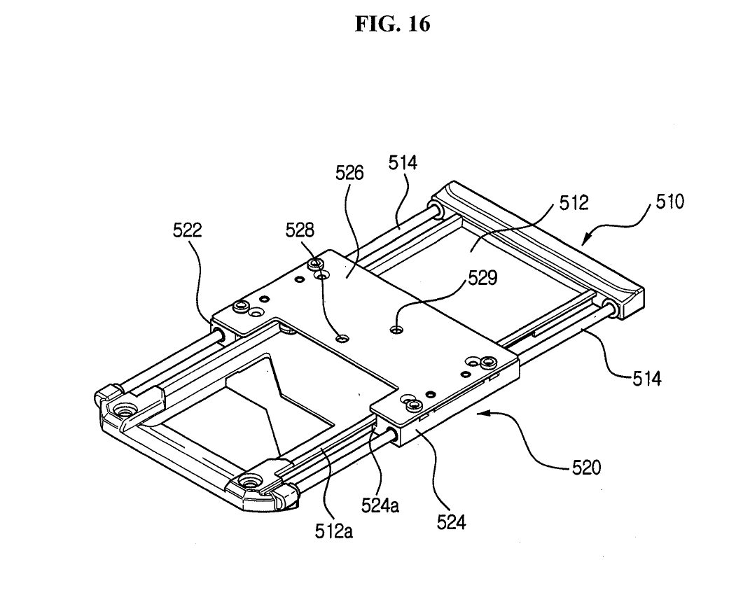

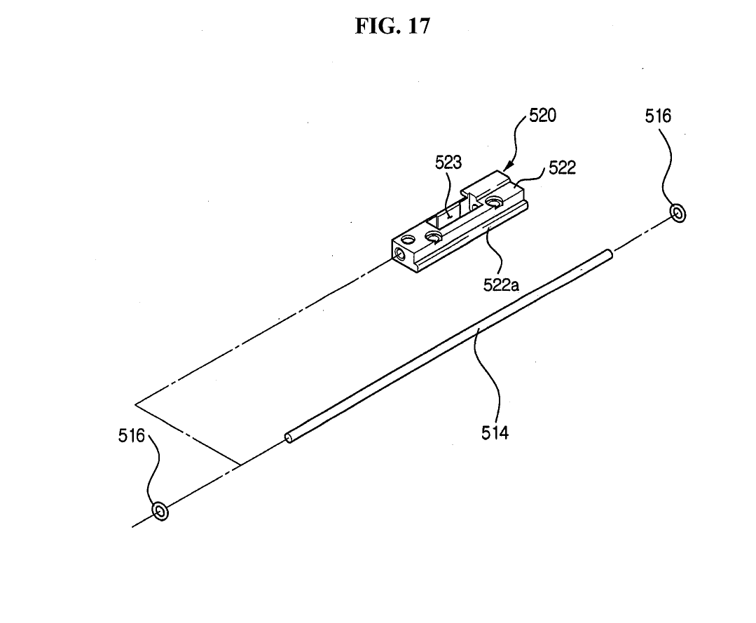

FIG. 16 is a top view illustrating a slide hinge device 500 according to a fourth embodiment of the present invention, and FIG. 17 is a perspective view illustrating the slide hinge device 500 of FIG. 16.

Referring to FIGS. 16 and 17, the slide hinge device 500 includes a rail hinge unit 510, a slide hinge unit 520, a first torsion spring 532, and a second torsion spring 534.

In a slide type personal portable device (not shown), the rail hinge unit 510 and slide hinge unit 520 are fixed to terminal bodies, respectively, and the terminal bodies may be open and closed in the slide type by movement between the rail hinge unit 510 and slide hinge unit 520 interposed between the terminal bodies. Generally, the rail hinge unit 510 is installed onto a front terminal body equipped with a display unit, and the slide hinge unit 520 is installed onto a rear terminal body equipped with a keypad and battery.

The terminal bodies include internal and external parts and circuit configuration including general terminal functions. The terminal bodies may include a terminal case, a keypad, a display module, a wireless communication module, a microphone, and a receiver. The internal configuration may be different according to manufacturers.

The rail hinge unit 510 includes a rail plate 512 and two guide bars 514 disposed at both sides of the rail plate 512 parallel to each other. However, a plurality of guide bars may be formed in other embodiments of the present invention, according to an intention of a designer.

An end of the guide bar 514 is contained and fixed to an extended portion of the rail plate 512. The rail plate 512 may be formed as one body formed of the same material and may not include a structure capable of being separated. However, in other embodiments of the present invention, according to an intention of the designer, additionally formed upper or lower supporters may be included.

Also, a guide sill 512a is formed in a longitudinal direction, on the side of the rail plate 512 adjacent the guide bar 514. The guide sill 512a prevents the slide hinge unit 520 becoming separating from the rail hinge unit 510. When the slide hinge unit 520 normally moves, the guide sill 512a is separated from the slide hinge unit 520 at a predetermined interval.

Also, a damper 516 formed in the shape of a ring is provided adjacent to a connection portion of the guide bar 514 and the rail plate 512. The damper 516 reduces an impact and noise which occur caused by direct contact between the slide hinge unit 520 and the rail hinge unit 510. The damper may have various cross-sections such as a circle or square. The damper 516 may be formed of crude rubber or other resins, such as conventional shock-absorbing rubber, having shock absorbing ability. Though the conventional shock-absorbing rubber is formed in the shape of a hat and covers the end of the guide bar 514, the damper 516 of FIGS. 16 and 17 is formed in the shape of a ring to control a position on the guide bar 514.

The slide hinge unit 520 includes slide guides 522 and 524 and a guide frame 526.

A penetration hole penetrating the center of the slide guides 522 and 524 is formed in the slide guides 522 and 524 for sliding of the slide guides 522 and 524 along the guide bar 514. Accordingly, the guide bar 514 and the slide guides 522 and 524 directly keep contact with each other while sliding. In this case, when the guide bar 514 rub against the slide guides 522 and 524 for a long time, dusts, noise, and abrasions caused by properties of materials used may be generated.

However, in the present invention, the slide guides 522 and 524 may be manufactured by using POM. In this case, POM has excellent mechanical, thermal, and chemical properties while in extended use over a wide temperature range. Also, since POM has notably better clipping resistance and fatigue resistance than other resins and has a self-lubricating property, POM is suitable for being used in forming the slide guides 522 and 524. However, in other embodiments, according to an intention of the designer, other lubricating materials such as polyamide and polyamide-imide may be substituted for the POM.

A marginal hole 523 may be provided on an upper part of the slide guides 522 and 524. The marginal hole 523 may provide a marginal space in the slide guides 522 and 524, and the guide bar 514 vertically passes through the marginal space. The slide guides may be manufactured by injection molding. In this case, to form a hole penetrating the slide guides 522 and 524, a core may be used. However, in actuality, it is not easy that one core is disposed to penetrate the slide guides 522 and 524 and drawn out without damaging molded products after molding. Accordingly, cores for injection molding may enter into both sides to form the marginal hole 523 in the slide guides 522 and 524. According to other embodiments of the present invention, a hole or groove may be formed in the slide guides in order to form a marginal hole for containing a guide bar.

Counter to forming the guide sill 512a on the side of the rail plate 512, guide protrusions 522a and 524a are formed on the side of the slide guides 522 and 524, opposite to the guide sill 512a. The guide protrusions 522a and 524a may be also formed continuously in a longitudinal direction of the slide guide 522 and 524. However, though the guide protrusions may be discontinuously formed, the guide protrusions may prevent the slide hinge unit and the rail hinge unit from mutual separation.

The slide guides 522 and 524 may rotate around the guide bar 514, respectively. However, since the slide guides 522 and 524 are connected to each other by the guide frame 526, the slide guides may only perform a linearly reciprocating motion along the guide bar 514. A locking hole for a screw or other locking elements is formed on the slide guides 522 and 524 and the guide frame 526. Accordingly, after molding the rail hinge unit 510 and the slide guides 522 and 524, the slide guides 522 and 524 are connected to each other by the guide frame 526, thereby providing the slide hinge unit 520.

As shown in FIG. 16, an elastic element interposed between the rail hinge unit 510 and the slide hinge unit 520 may be further included. The elastic element may provide two directions of repulsion forces, which are opposite to each other and switched at a point on a movement path of the slide hinge unit 520. Accordingly, when a user transfers a first terminal body by a certain distance from an initial position, a direction of force between the hinge unit 510 and the slide hinge unit 520 is switched, such that the first terminal body automatically moves on other paths. For this, the elastic element includes the first torsion spring 532 and the second torsion spring 534. The first torsion spring 532 is connected to a first spring bush 518 of the rail hinge unit 510 and a first spring rivet 528 of the slide hinge unit 520 to rotate, and the second torsion spring 534 is connected to a second spring bush 519 of the rail hinge unit 510 and a second spring rivet 529 of the slide hinge unit 520 to rotate.

Hereinafter, a method of manufacturing the slide hinge device 500 of FIG. 16 will be described.

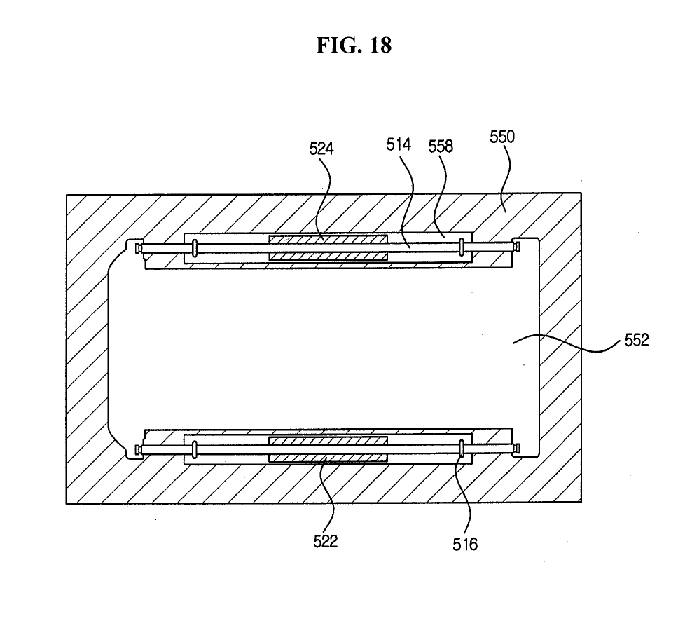

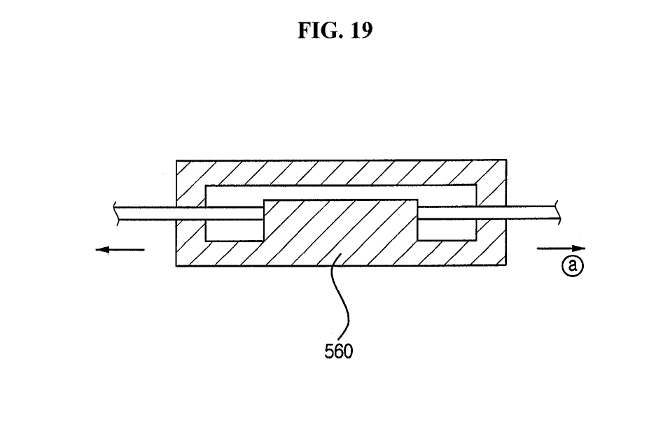

FIG. 18 is a cross-sectional view illustrating a first mold for describing a method of manufacturing the slide hinge device of FIG. 16, and FIG. 19 is a cross-sectional view illustrating a second mold for describing a method of manufacturing the slide hinge device of FIG. 16.

Referring to FIGS. 18 and 19, the guide bar 514, the slide guides 522 and 524, and the damper 516 are provided. Since a part of the end of the guide bar 514 is contained by the rail plate 512 via casting or injection molding, an inner projection is formed on the end of the guide bar 514, thereby securely fixing the end of the guide bar 514 to the rail plate 512.

Also, after inserting the guide bar 514 into the penetration hole of the slide guides 522 and 524, the damper 516 is slipped on both ends of the guide bar 514. The guide bar 514 and the slide guides 522 and 524 are disposed in the first mold 550. In this case, the guide bar 514, the slide guides 522 and 524, and the damper formed in the shape of an O-ring are slipped on the guide bar 514 and disposed in a marginal space 558. In this case, the marginal space 558 is a space for temporarily protecting the damper 516 rather than a space for molding. At the beginning of a process of slipping the damper 516 on the guide bar 514, a position of insertion may be controlled in order to dispose the damper 516 in the marginal space 558.

The rail hinge unit 510 containing the both ends of the guide bar 514 may be formed by using injection molding in a mold space 552 of the first mold 550. Accordingly, since the guide bar 514 and the rail hinge unit 510 may be formed of one body, the structure of them is very durable. Upper and lower ends of the rail hinge unit 510 may be molded to be extended toward the both sides and may fix the both ends of the guide bar 514. However, in other embodiments of the present invention, according to an intention of the designer, the shape of the rail hinge unit may be variously molded. The slide guides 522 and 524 are connected in one body by using the guide frame 526, thereby completing the slide hinge device 500.

To mold the rail plate 512, die casting or insert injection molding may be used. Accordingly, metal such as aluminum may be used in addition to resins such as engineering plastic (EP).

In the mold 550, the first mold space 552 includes a guide sill molding part for molding the guide sill 512a formed in a longitudinal direction on the side of the rail hinge unit 510, and an end of the guide sill molding part is horizontally formed. Accordingly, the guide protrusion molding part faces a vertical direction or other directions and cross the guide protrusion 524a formed on the slide guides 522 and 524.

Consequently, the molded rail plate 512 and the slide guides 522 and 524 are formed as one body with the guide bar 514. The guide protrusion 524a of the slide guides 522 and 524 is turned downward. Accordingly, in the process of molding, the guide protrusion 524a is turned upward or downward, thereby escaping vertically overlapped portions and molding the slide guides 522 and 524 simultaneously with maintaining a state of being engaged with the rail hinge unit 510.

The guide protrusion 524a may be engaged with the guide sill 512a by rotating the molded slide guides 524 and 525. Also, the vertically duplicated portion may be removed by rotating the slide guides 522 and 524 by approximately 90 degrees, and the guide protrusion 524a faces the guide sill 512a by rotating the slide guides 522 and 524 to their original positions.

Also, the locking hole is turned upward by rotating the slide guides 522 and 524, and the slide guides 522 and 524 may be coupled together by the guide frame 526. The slide guides 522 and 524 may form one body by using the guide frame 526 and may move along the guide bar 514 according to movement of the guide frame 526.

In this case, before or after assembling the guide frame 526, the first and second torsion springs 532 and 534 may be interposed between the rail hinge unit 510 and the slide hinge unit 520. The first torsion spring 532 is connected to the first spring bush 518 of the rail hinge unit 510 and the first spring rivet 528 of the slide hinge unit 520 to rotate, and the second torsion spring 534 is connected to the second spring bush 519 of the rail hinge unit 510 and the second spring rivet 529 of the slide hinge unit 520.

As described above, after manufacturing the slide hinge device 500, the rail hinge unit 510 and the slide hinge unit 520 may be installed onto the first terminal body and the second terminal body of the personal portable device, respectively. The first and second terminal bodies may reciprocate by the slide hinge device 500, and the rail hinge unit 510 and the slide hinge unit 520 may relatively move by using the guide bar 514, thereby stably moving.

Referring to FIG. 19, the slide guides 522 and 524 may be injection molded by using a second mold 560. In the second mold 560, since a part is protruded toward inside the mold space 560, the marginal hole 523 may be in the slide guides 522 and 524 in the injection molding. The core enters into both sides of the marginal hole 523, to form a penetration hole for the guide bar 514 on the slide guides 522 and 524@. Accordingly, since the slide guides 522 and 524 have an area contacting the second mold 560 relatively broader than the conventional method, material in the injection molding may be quickly cooled, thereby increasing productivity. In this case, the slide guides 522 and 524 may be manufactured by using POM. However, in other embodiments of the present invention, according to intention of the designer, a marginal hole in slide guides may be omitted.

Accordingly, in the slide hinge device according to the present invention, the slide hinge unit 520 may be manufactured by using self-lubricating material. Therefore, when the slide hinge unit 520 slides on the guide bar 514, a dust may be not generated and a feel of sliding may be improved. Also, the slide hinge device has excellent mechanical, thermal, and chemical properties, and better clipping resistance and fatigue resistance than conventional hinge devices.

Also, an additionally manufactured upper or lower supporter is not required, the rail hinge unit may be formed in one body. Accordingly, since additional assembling is not required in assembling the slide hinge device, a process of assembling becomes simple.

Also, since the rail hinge unit 520 is formed in a state in which the slide guides 522 and 524 are combined with the guide bar 514, combining the guide bar 514 with the rail hinge unit 520 is not required, thereby reducing errors in dimensions, and conveniently manufacturing. Also, the torsion spring is installed before or after fixing the guide frame, thereby adding a semi-auto opening and closing function. Also, after manufacturing, since the parts are passively fitted to each other, a defect due to the dimension may be prevented and a precision just like precision engineering may be provided.

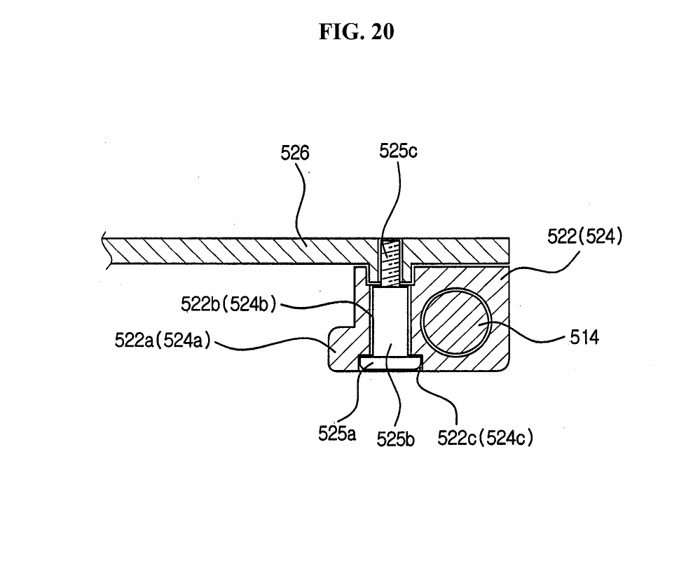

FIG. 20 is a partial cross-sectional view illustrating a screw hole of a slide guide according to an embodiment of the present invention.

Referring to FIG. 20, a screw hole 522b and 524b for engaging with the guide frame 526 may be formed in the slide guides 522 and 524. In this case, at an entrance of the screw holes 522b and 524b, counter-bores 522c and 524c for supporting the head of a screw 525 are formed. The screw 525 includes a screw head 525a, a screw body 525b having a diameter smaller than the screw head 525a, and a thread portion 525c formed in the end of the screw body. Since the screw 525 may be a double step screw and is not locked inside the guide frame 526 more than required, damage of the slide guides 522 and 524 due to adding unnecessary force may be prevented and deformation of the screw hole 522b and 524b may be prevented. However, in other embodiments of the present invention, according to an intention of the designer, the shape of guide frame and slide guide may be variously established corresponding to the screw.

### Embodiment 5

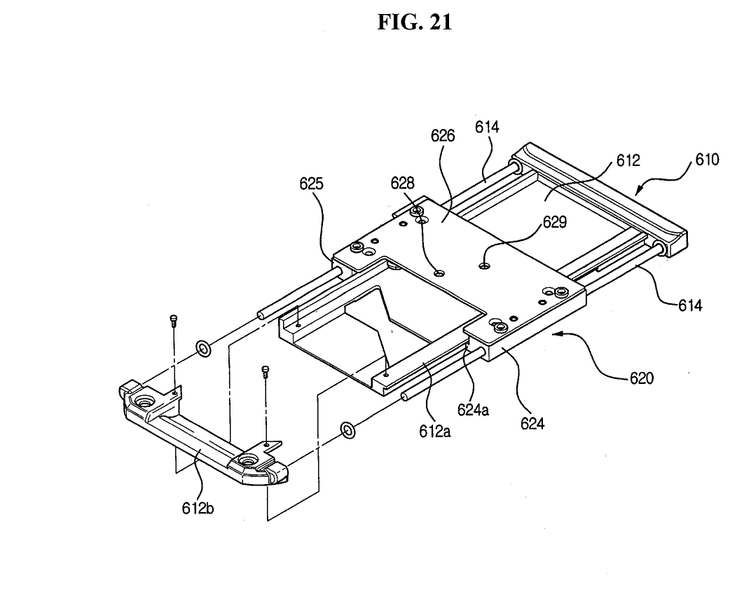

FIG. 21 is an exploded perspective view illustrating a slide hinge device according to a fifth embodiment of the present invention.

Referring to FIG. 21, the slide hinge device includes rail hinge unit 610 and slide hinge unit 620.

In the rail hinge unit 610, an end supporter 612b may be additionally locked by a screw. Accordingly, the slide hinge unit 620 may be engaged with a guide bar 614 and be installed onto the rail hinge unit 610 in order to slide. In this case, the end supporter 612b contains an end of the guide bar 614 to engage with the rail hinge unit 610. As described above, a stable hinge structure may be maintained by using the end supporter 612b. In this case, in other embodiments of the present invention, the slide hinge unit may be formed as one body without assembly.

A guide sill 612a is formed along a longitudinal direction on the side of a rail plate adjacent to the guide bar 614. The guide sill 612a is for preventing the slide hinge unit 620 becoming separated from the rail hinge unit 610 by a guide protrusion 624a. When the slide hinge unit 620 normally moves, the guide sill 612a is separated from the slide hinge unit 620 at a predetermined interval.

Also, since slide guides 624 and 625 are connected to each other by a guide frame 626, the slide guides 624 and 625 may perform a linearly reciprocating motion along the guide bar 614. An end of a first torsion spring may be connected to a first spring rivet 628, and an end of a second torsion spring may be connected to a second spring rivet 629.

In addition, since the rail hinge unit 610 and the slide hinge unit 620 are substantially identical with the fourth embodiment, and function and effect of elements are substantially identical, the description and the drawings of the previous embodiment may be referred to in the description of the present embodiment and duplicated contents will be omitted.

### INDUSTRIAL APPLICABILITY

The slide hinge device may be simply manufactured, a number of processes for manufacturing may be reduced, and a defect rate of the products may reduced, thereby being very economical.

Also, after manufacturing, since the parts are passively fitted to each other, a defective due to the dimension may be prevented, a precision just like precision engineering may be provided, and a process of assembling becomes simple because an additional assembling is not required.

Also, in the slide hinge device, a slide hinge unit may be manufactured by using self-lubricating material. Therefore, when the slide hinge unit slides on a guide bar, a dust may be not generated and a feel of sliding may be improved.

Also, before or after fixing the guide frame, a torsion spring may be installed to add a semi-auto opening and closing function, and when applying to a personal portable device, providing an excellent feel of sliding to users.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A slide hinge device comprising:
a rail hinge unit including a rail plate and at least one guide bar disposed parallel with a side of the rail plate; and
a slide hinge unit including a slide guide, in which a penetration hole corresponding to the at least one guide bar is formed in a center thereof, for sliding along the guide bar and a guide frame bound with the slide guide as one body.

2. The hinge device of claim 1, further comprising an elastic element interposed between the rail hinge unit and the slide hinge unit, the elastic element providing two directions of repulsion forces, which are opposite to each other and switched at a point on a movement path of the slide hinge unit.

3. The hinge device of claim 2, wherein the elastic element includes a torsion spring whose one end is engaged with the rail hinge unit and an other end is engaged with the slide hinge unit.

4. The hinge device of claim 1, wherein:
a guide sill is formed lengthwise on a side of the rail plate; and
a guide protrusion corresponding to the guide sill is formed in the slide guide.

5. The hinge device of claim 1, wherein a damper in the shape of an O-ring containing the guide bar is provided in a connection part of the guide bar and the rail plate.

6. The hinge device of claim 1, wherein a moving bush is provided between the guide bar and the slide guide, the moving bush sliding with the slide guide along the guide bar.

7. The hinge device of claim 6, wherein the moving bush is formed of a heat resistant material.

8. The hinge device of claim 6, wherein a lubricating bush is provided between the guide bar and the moving bush, the lubricating bush sliding with the moving bush along the guide bar.

9. The hinge device of claim 8, wherein an inner projection for fixing the lubricating bush is formed on the inner surface of the moving bush.

10. The hinge device of claim 1, wherein the slide guide is formed of a self-lubricating material.

11. A slide hinge device comprising:
a rail hinge unit including a rail plate and at least one guide bar disposed parallel with a side of the rail plate; and
a slide hinge unit including a slide guide, in which a penetration hole corresponding to the guide bar is formed in a center thereof, formed of a self-lubricating material and a guide frame bound with the slide guide as one body.

12. The hinge device of claim 11, wherein the slide guide is formed by using one of polyoxymethylene, polyamide, and polyamide-imide.

13. The hinge device of claim 11, wherein:
a marginal space is formed in the slide guide; and
two concentric holes for the guide bar are formed in both sides of the slide guide around the marginal space.

14. The hinge device of claim 11, wherein the rail hinge unit further comprises end supporters mounted on both ends of the rail plate for fixing both ends of the guide bar respectively.

15. The hinge device of claim 11, wherein upper and lower ends of the rail hinge are laterally and outwardly extended and the extended portions of its upper and lower ends of the rail hinge contain and fix the both ends of the guide bar.

16. The hinge device of claim 11, wherein:
a screw hole for binding the guide frame is formed in the slide guide; and
a counter-bore for receiving and supporting the head of a screw is formed at an entrance of the screw hole,
wherein the screw is a double step screw including a screw head, a screw body having a diameter smaller than the screw head for the screw hole, and a thread portion formed in an end of the screw body, the thread portion engaged with the guide frame.

17. A personal portable device comprising:
a first terminal body;
a rail hinge unit including a rail plate installed on the first terminal body and at least one guide bar disposed parallel with a side of the rail plate;
a slide hinge unit including a slide guide, in which a penetration hole corresponding to the guide bar in a center thereof, for sliding along the guide bar and a guide frame bound with the slide guide as one body; and
a second terminal body installed to the guide frame and sliding on the first terminal body.

18. The portable device of claim 17, further comprising a moving bush interposed between the slide guide and the guide bar to slide with the slide guide.

19. The portable device of claim 17, further comprising a lubricating bush interposed between the guide bar and the moving bush to slide along the guide bar.

20. The portable device of claim 19, wherein an inner projection for fixing the lubricating bush is formed on an inner surface of the moving bush.

21. The portable device of claim 17, wherein the slide guide is formed of polyoxymethylene, polyamide, and polyamide-imide.

22. The portable device of claim 21, wherein:
a marginal space is formed in a part of the slide guide; and
two concentric holes for the guide bar are formed in both sides of the slide guide around the marginal space.

23. The portable device of claim 17, wherein:
a guide sill is formed lengthwise on a side of the rail plate; and
a guide protrusion corresponding to the guide sill is formed in the slide guide.

24. The portable device of claim 17, wherein a damper in the shape of an O-ring containing the guide bar is provided in a connection part of the guide bar and the rail plate.

25. The portable device of claim 17, further comprising an elastic element interposed between the rail hinge unit and the slide hinge unit, the elastic element providing two directions of repulsion forces, which are opposite to each other and switched at a point on a movement path of the slide hinge unit to semi-automatically open and close the first and second terminal bodies.

26. The portable device of claim 25, wherein the elastic element includes a torsion spring whose one end is engaged with the rail hinge unit and the other end is engaged with the slide hinge unit.

27. A method of manufacturing a slide hinge device, comprising:
providing a guide bar and a moving bush containing the guide bar, the moving bush capable of sliding along the guide bar;
disposing the guide bar and the moving bush in a mold;
molding a rail hinge unit containing both ends of the guide bar and a slide guide containing the moving bush by using the mold; and
binding a guide frame to the slide guide.

28. The method of claim 27, wherein the providing the moving bush comprises providing a lubricating bush containing the guide bar to slide along the guide bar and a moving bush containing the lubricating bush and fixing the lubricating bush by using an inner projection formed on the inner surface thereof.

29. The method of claim 27, wherein, in the molding the rail hinge unit and the slide guide by using the mold, a first mold cavity for the rail hinge unit is provided and a second mold cavity for the slide guide is provided, the second mold cavity separated from the first mold cavity.

30. The method of claim 29, wherein:
the first mold cavity includes a guide sill molding portion for molding a guide sill formed lengthwise on the side of the rail hinge unit; and
the second mold cavity includes a guide protrusion molding portion for molding a guide protrusion according to the guide sill, the guide protrusion molding portion facing a different direction in order to cross the guide sill molding portion.

31. The method of claim 27, wherein:
the slide hinge unit is molded in a different direction to cross each other to the rail hinge unit;
the slide guide is rotated such that the guide sill faces the guide protrusion; and
the slide guide is mutually bound with the guide frame.

32. The method of claim 27, wherein an elastic element is interposed between the rail hinge unit and the slide hinge unit to provide two directions of repulsion forces, which are opposite to each other and switched at a point on a movement path of the slide hinge unit.

33. The method of claim 32, wherein the elastic element includes a torsion spring whose one end is engaged with the rail hinge and the other end is engaged with the slide hinge.

34. The method of claim 27, wherein a damper in the shape of O-ring is slipped on the guide bar before the providing a guide bar and a moving bush, the damper disposed in a peripheral available space separated from the mold when molding the rail hinge unit and the slide hinge unit.

35. A method of manufacturing a slide hinge device, comprising:
providing a guide bar and a slide guide, in which a penetration hole corresponding to the guide bar is formed, formed of a self-lubricating material;
disposing the guide bar and the slide guide in a first mold;
molding a rail hinge unit containing both ends of the guide bar, by using the first mold; and
binding a guide frame to the slide guide.

36. The method of claim 35, wherein the slide guide is injection molded in a mold cavity by using a second mold.

37. The method of claim 36, wherein:
the second mold includes a protrusion for forming a predetermined marginal space in the slide guide; and
two cores penetrate inwardly from both sides of the second mold around the marginal space to form two concentric holes for the guide bar in the slide guide.
